(19) United States
(12) Patent Application Publication
(10) Pub. No.: US 2026/0054314 A1
(43) Pub. Date: Feb. 26, 2026

(54) HYBRID POWERED BED FUSION/DIRECTED ENERGY DEPOSITION DISTORTION MITIGATION STRUCTURE

(71) Applicant: RTX Corporation, Farmington, CT (US)

(72) Inventors: Lawrence Binek, Glastonbury, CT (US); Brendan Gustafson, Vernon, CT (US); Joseph Ott, Enfield, CT (US); Dean Sirois, Enfield, CT (US)

(21) Appl. No.: 18/763,914

(22) Filed: Jul. 3, 2024

(51) Int. Cl. B22F 10/25; B22F 10/28; B33Y 10/00; B33Y 80/00

(52) U.S. Cl. CPC B22F 10/25; B22F 10/28; B33Y 10/00; B33Y 80/00

(57) ABSTRACT

A component includes a component segment, a foundation built on the component segment, and a plurality of distortion mitigation structures built on the component segment. The component segment, foundation, and the plurality of distortion mitigation structures are built with a first additive manufacturing (AM) technique. The component further includes a boss built on the foundation using a second AM technique. The plurality of distortion mitigation structures are configured to radiate away from the foundation and to dissipate heat generated on the foundation when the boss is built using the second AM technique.

The present disclosure relates generally to forming raised structures on surfaces of components and, more particularly, to an approach for forming such raised structures using additive manufacturing techniques.

Protruding or raised features formed on surfaces of components are often referred to as “bosses. ” Such features are typically cylindrical or conical projections added to a component for specific purposes, such as providing structural support, facilitating connections, enabling ease of assembly and disassembly in various mechanisms, etc. The bosses can be open (i.e., surrounding an orifice) or closed structures and can be solid or hollow structures as appropriate for a particular application.

For example, bosses can be used as structural reinforcements to enhance the strength and durability of a component. Addition of bosses to areas of a component that experience stress or load can reduce component failure in high wear conditions. Bosses are often used as attachment points for threaded fasteners such as bolts and screws, allowing for easy assembly and disassembly of structures. In some applications, bosses are used as connectors for pipes, tubes, or hoses. Bosses can also be used to house electrical components or connectors or can function as secure attachment points for cables, connectors, and other electrical elements. The inclusion of bosses in engineering designs can provide for enhanced strength by significantly improving the load-bearing capacity of components, precise assembly by providing clear attachment points, and modularity by promoting easy assembly, disassembly, and replacement of components.

### SUMMARY

One aspect of this disclosure is directed to a component including a component segment, a foundation built on the component segment, and a plurality of distortion mitigation structures built on the component segment. The component segment, foundation, and the plurality of distortion mitigation structures are built with a first additive manufacturing (AM) technique. The component further includes a boss built on the foundation using a second AM technique. The plurality of distortion mitigation structures are configured to radiate away from the foundation and to dissipate heat generated on the foundation when the boss is built using the second AM technique.

Another aspect of this disclosure is directed to a method of making a component. A component segment including an integral foundation for a boss and a plurality of distortion mitigation features is built on a build platform of a first AM device using a first AM technique. The component segment is removed from the first AM device and moved to a second AM device. An energy/powder head of a second AM device is positioned over the integral foundation using the integral foundation as a location datum. The boss is built on top of the integral foundation using the energy/powder head of the second AM device and a second AM technique to build a completed component. The completed component is removed from the second AM device.

### BRIEF DESCRIPTION OF THE DRAWINGS

FIG. 1 is a schematic representation of a component that includes a boss.

FIG. 2A is a schematic representation of a component that includes a boss and distortion mitigation structures of the present disclosure.

FIG. 2B is an overhead schematic representation of a component that includes a boss and distortion mitigation structures of the present disclosure.

FIG. 2C is a more detailed schematic representation of the distortion mitigation structures of the present disclosure.

FIG. 3 is a flowchart of the process of forming a component with a boss and the distortion mitigation structures of the present disclosure.

### DETAILED DESCRIPTION

Bosses are commonly used on components, including aerospace components, for a variety of reasons, including to enhance component strength by significantly improving the load-bearing capacity of the component, allowing for precise assembly by providing clear attachment points, and other reasons. Conventional construction techniques for components with bosses include casting the component and boss together, welding the boss to a substrate component, and other conventional techniques.

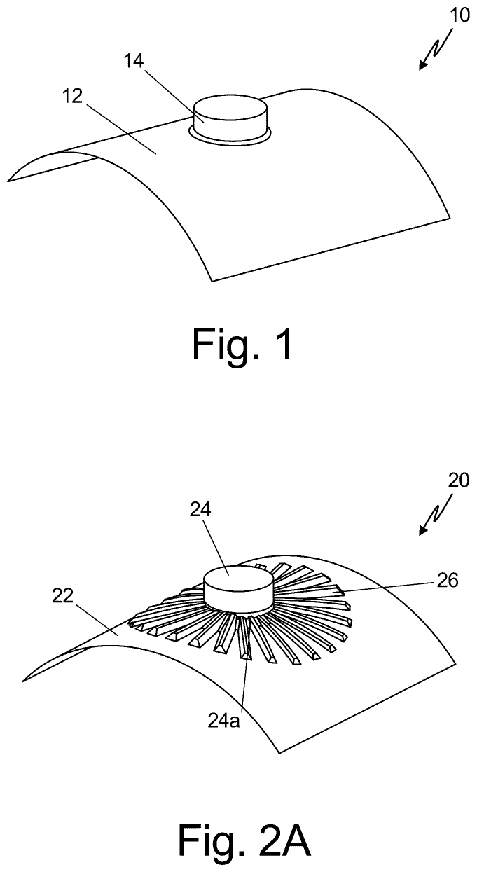

Additive manufacturing (AM) techniques can also be used to make components with bosses, but such techniques can be problematic, particularly for large components. For example, building the boss as an integral portion of a larger assembly using a first AM technique, such as a laser powder bed fusion (PBF-LB) or an electron beam powder bed fusion (PBF-EB) technique, can encounter challenges addressing the thermal stresses imparted during the AM build process. This challenge can be particular pronounced if the component has a relatively thin wall that provides a limited heat sink to mitigate thermal affects associated with the AM technique. For example, the component 10 shown in FIG. 1, which can be a gas turbine engine component such as a component segment 12 of a gas turbine engine case, a housing, or other component can have a relatively thin wall (e.g., 0.025 inches [0.001 mm] thick) with a boss 14 attached to it. The mass of the component segment 12 can be insufficient to act as a heat sink to address the thermal stresses of forming the boss 14 on the component 10 using AM techniques.

One option to building the part exclusively using a single AM technique is to make the component segment 12 using a first AM technique, such as PBF-LB or PBF-EB, and using a second AM technique, such as Directed Energy Deposition (DED), to form the boss 14 on the component segment 12. The first and second AM techniques can also be other AM techniques that are deemed appropriate for a particular build. While using a combination of AM techniques allows the individual portions of the finished component 10 to be made with preferred techniques (i.e., PBF-LB for the relatively large component segment 12 and DED for the smaller, more prominent boss 14) experience has shown that when using conventional PBF-LB design guidelines to build the component segment 12, using DED techniques to build a boss 14 on a component segment 12 having a relatively thin wall can create a heat affected zone that results in a build failure with the boss 14 feature and neighboring component segment 12 becoming distorted. Increasing the build angle of the boss 14 to ameliorate distortion caused by the DED process thermal effects undesirably increases part mass and build time. Similarly, increasing the component segment 12 thickness to create a more robust heat sink to address the DED process thermal effects also undesirably increases part mass and build time.

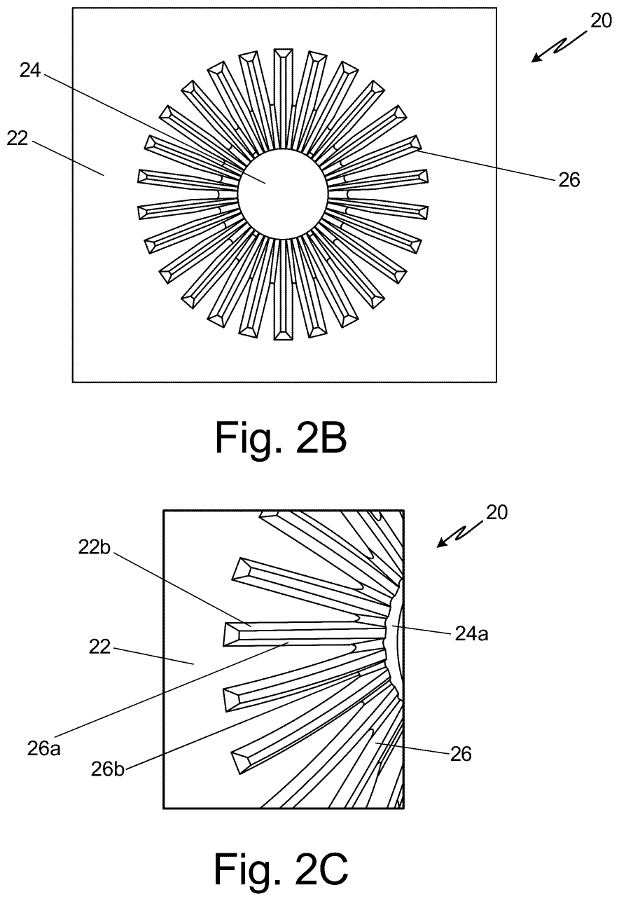

FIGS. 2A and 2B show another component 20 design that includes a plurality of distortion mitigation structures 26 built on the component segment 22 and surrounding the boss 24. The plurality of distortion mitigation structure 26 function as a heat exchanger to direct heat from the immediate vicinity of the boss 24 to outlying portions of the component segment 22 and as a heat sink to add a selected amount of mass to absorb heat from the second AM technique (e.g., a DED process) used to form the boss 24. The structure of the component 20 includes a component segment 22 (substrate) built with a first AM technique (e.g., PBF-LB). The first AM technique (e.g., PBF-LB) build of the component segment 22 can include an integral foundation 24a for the boss 24. The distortion mitigation structures 26 can also be built as part of the first AM technique (e.g., PBF-LB) build of the component segment 22. The distortion mitigation structures 26 radiate from the foundation 24a and help move the thermal effects from the second AM (e.g., DED) process to a larger area on the component segment 22, thereby dissipating heat associated with the second AM (e.g., DED) process. The foundation 24a, which can be of limited height (e.g., 0.25 inches [0.1 mm]), can provide a datum for the second AM (e.g., DED) deposition of the boss 24, thereby increasing the volume of the boss 24 applied with the second AM (e.g., DED) process. The dimensions of the foundation 24a should be selected to be appropriate to a particular application and may, for example, be based on the volume of the boss 24 to be built on the foundation 24a.

FIG. 2C shows additional details of the plurality of distortion mitigation structures 26. Each of the plurality of distortion mitigation structures 26, which are formed as webbing ligaments, should have a shape that is readily formed using the first AM (e.g., PBF-LB) techniques, such as the illustrated elongated trapezoidal prism. Any other appropriate shape, particularly a shape that is self-supporting, for example only, a tetrahedral or triangular prism shape, a bead of tapering width, etc. can also be selected. Each of the plurality of distortion mitigation structures 26 need not be identical. In some examples, it may be appropriate for webbing ligaments of the distortion mitigation structures 26 that are close to a horizontal axis near the boss 24 to have a different chamfer height 26a to account for curvature of the component segment 20. In some examples, the plurality of distortion mitigation structures 26 may include a blend radius 26b between the individual ligaments to reduce stress on the ligaments associated with tight angles and abrupt geometry changes. Depending on the application for which the component 20 is intended, a designer can balance the volume of material used for the plurality of thermal mitigation structures 26 against the requirement to conduct heat away from the boss 24 during the second AM (e.g., DED) build process used to form the boss 24. As illustrated in FIG. 2C, the plurality of distortion mitigation structures 26 will require very minimal post processing.

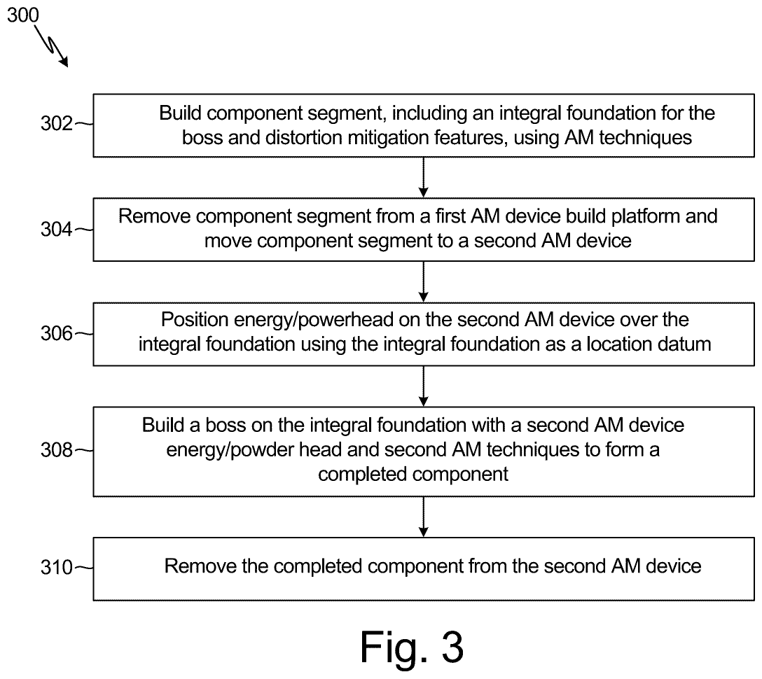

FIG. 3 is a flowchart of a method 300 for forming the component 20 with the plurality of distortion mitigation structures 26. At step 302, the component segment 22 is built using first AM (e.g., PBF-LB) techniques. The component segment 22 build includes an integral foundation 24a for the boss 24 and the distortion mitigation structures 26 as discussed above. At step 304, the component 20 is removed from a first AM (e.g., PBF-LB) device build platform and moved to a second AM (e.g., DED) device. The first AM device build platform and associated first AM device can be any such device deemed appropriate to form the component segment 22 with associated integral foundation 24a and the distortion mitigation structures 26. Similarly, the second AM device can be any such device deemed appropriate to build a boss 24 with a desired geometry on the integral foundation 24a. At step 306, the a second AM (e.g., DED) device energy/powerhead is positioned over the integral foundation 24a, using the integral foundation 24a as a location datum. At step 308, the second AM device energy/powder head builds a boss 24 with the desired geometry on top of the integral foundation 24a to complete the component 20 build. At step 310, the completed component is removed from the second AM device. A person of ordinary skill will know how to select appropriate AM devices and perform each of the AM steps based upon the present disclosure and knowledge of AM processes.

A person of ordinary skill will recognize that the materials used to make the component 20 can be any of the materials typically used for the applications for which the component 20 is intended. For example, if the component 20 can be used in a gas turbine application, the material used to make the component 20 can be a titanium alloy, an aluminum alloy, a superalloy, a specialty steel or other appropriate material.

By using multiple AM processes to build the component 20, the definition (e.g., height, width, diameter, thickness, etc.) of the boss 24 is largely decoupled from the somewhat constrained PBF-LB design rules. For example, a large diameter or tall boss 24 can be built with DED techniques on the component segment 22, which is made with PBF-LB techniques, without significant additional support structure. This approach can reduce cost for an additive solution and minimize post processing times. Because each of the selected first and second AM techniques leaves a residual indication of the selected technique used to build each feature (e.g., in the layers and or microstructure of the parts made with the technique), it is possible to determine which technique was used to build each feature.

### Discussion of Possible Embodiments

The following are non-exclusive descriptions of possible embodiments of the present invention.

A component comprises a component segment, a foundation built on the component segment, and a plurality of distortion mitigation structures built on the component segment, wherein the component segment, foundation, and the plurality of distortion mitigation structures are built with a first additive manufacturing (AM) technique and a boss built on the foundation using a second AM technique. The plurality of distortion mitigation structures are configured to radiate away from the foundation and to dissipate heat generated on the foundation when the boss is built using the second AM technique.

The component of the preceding paragraph can optionally include, additionally and/or alternatively, any one or more of the following features, configurations and/or additional elements:

The component, wherein the plurality of distortion mitigation structures are built as a web on ligaments extending from the foundation.

The component, wherein each of the ligaments of the plurality of distortion mitigation structures includes a chamfer.

The component, wherein each of the ligaments of the plurality of distortion mitigation structures includes a blend radius configured to reduce stress on each of the ligaments.

The component, wherein each of the ligaments of the plurality of distortion mitigation structures is a tetrahedral prism.

The component, wherein the first AM technique is a laser powder bed fusion technique.

The component, wherein the second AM technique is a directed energy deposition technique.

The component, wherein the component is a gas turbine engine component.

The component, wherein the gas turbine engine component is a case or a housing.

The component, wherein the gas turbine engine component is made from an aluminum alloy, a titanium alloy, a superalloy, or a specialty steel.

A method of making a component comprises building, using a first additive manufacturing (AM) technique, a component segment, including an integral foundation for a boss and a plurality of distortion mitigation features on a build platform of a first AM device. The component segment is removed from the first AM device and moved to a second AM device. An energy/powder head of a second AM device is positioned over the integral foundation using the integral foundation as a location datum and the boss is built on top of the integral foundation using the energy/powder head of the second AM device and a second AM technique to build a completed component. The completed component is removed from the second AM device.

The method of the preceding paragraph can optionally include, additionally and/or alternatively, any one or more of the following features, configurations and/or additional elements:

The method, wherein the plurality of distortion mitigation structures are built as a web on ligaments extending from the foundation.

The method, wherein each of the ligaments of the plurality of distortion mitigation structures includes a chamfer.

The method, wherein each of the ligaments of the plurality of distortion mitigation structures includes a blend radius configured to reduce stress on each of the ligaments.

The method, wherein each of the ligaments of the plurality of distortion mitigation structures is a tetrahedral prism.

The method, wherein the first AM technique is a laser powder bed fusion (PBF-LB) technique and the first AM device is a PBF-LB device.

The method, wherein the second AM technique is a directed energy deposition (DED) technique and the second AM device is a DED device.

The method, wherein the component is a gas turbine engine component.

The method, wherein the gas turbine engine component is a case or a housing.

The method, wherein the gas turbine engine component is made from an aluminum alloy, a titanium alloy, a superalloy, or a specialty steel.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A component, comprising:
a component segment, a foundation built on the component segment, and a plurality of distortion mitigation structures built on the component segment, wherein the component segment, foundation, and the plurality of distortion mitigation structures are built with a first additive manufacturing (AM) technique; and
a boss built on the foundation using a second AM technique;
wherein the plurality of distortion mitigation structures are configured to radiate away from the foundation and to dissipate heat generated on the foundation when the boss is built using the second AM technique.

2. The component of claim 1, wherein the plurality of distortion mitigation structures are built as a web on ligaments extending from the foundation.

3. The component of claim 2, wherein each of the ligaments of the plurality of distortion mitigation structures includes a chamfer.

4. The component of claim 3, wherein each of the ligaments of the plurality of distortion mitigation structures includes a blend radius configured to reduce stress on each of the ligaments.

5. The component of claim 3, wherein each of the ligaments of the plurality of distortion mitigation structures is a tetrahedral prism.

6. The component of claim 1, wherein the first AM technique is a laser powder bed fusion technique.

7. The component of claim 1, wherein the second AM technique is a directed energy deposition technique.

8. The component of claim 1, wherein the component is a gas turbine engine component.

9. The component of claim 8, wherein the gas turbine engine component is a case or a housing.

10. The component of claim 9, wherein the gas turbine engine component is made from an aluminum alloy, a titanium alloy, a superalloy, or a specialty steel.

11. A method of making a component, comprising:
building, using a first additive manufacturing (AM) technique, a component segment, including an integral foundation for a boss and a plurality of distortion mitigation features on a build platform of a first AM device;
removing the component segment from the first AM device;
moving the component segment to a second AM device;
positioning an energy/powder head of a second AM device over the integral foundation using the integral foundation as a location datum;
building, using the energy/powder head of the second AM device and a second AM technique, the boss on top of the integral foundation to build a completed component;
removing the completed component from the second AM device.

12. The method of claim 11, wherein the plurality of distortion mitigation structures are built as a web on ligaments extending from the foundation.

13. The method of claim 12, wherein each of the ligaments of the plurality of distortion mitigation structures includes a chamfer.

14. The method of claim 13, wherein each of the ligaments of the plurality of distortion mitigation structures includes a blend radius configured to reduce stress on each of the ligaments.

15. The method of claim 13, wherein each of the ligaments of the plurality of distortion mitigation structures is a tetrahedral prism.

16. The method of claim 11, wherein the first AM technique is a laser powder bed fusion (PBF-LB) technique and the first AM device is a PBF-LB device.

17. The method of claim 11, wherein the second AM technique is a directed energy deposition (DED) technique and the second AM device is a DED device.

18. The method of claim 11, wherein the component is a gas turbine engine component.

19. The method of claim 18, wherein the gas turbine engine component is a case or a housing.

20. The method of claim 19, wherein the gas turbine engine component is made from an aluminum alloy, a titanium alloy, a superalloy, or a specialty steel.
